(19) United States
(12) Patent Application Publication
(10) Pub. No.: US 2006/0248179 A1
(43) Pub. Date: Nov. 2, 2006

(54) Method and system for event-driven network management

(76) Inventors: Michael E. Short, Orangevale, CA (US); Daniel Edley Ford, Granite Bay, CA (US); Adrian Cowham, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/118,846

(22) Filed: Apr. 29, 2005

(51) Int. Cl. G06F 15/173

(52) U.S. Cl. 709/223

(57) ABSTRACT

A method and system for event-driven network management. A network management application is configured to detect a network event generated by an external application and to execute an action in response to detecting said network event, wherein the network management application is configurable to receive information describing the network event and the action. The network event is monitored for. In response to detecting the network event, the action is executed.

### TECHNICAL FIELD

Embodiments of the present invention relate to the field of network management. More specifically, embodiments of the present invention relate to a method and system for event-driven network management.

### BACKGROUND ART

Network management systems are used to monitor a distributed computer network in order to diagnose problems and collect statistical information for maintaining the network. As the network management system monitors the network, various network events can be generated by the network management system in response to detecting certain network conditions. These network events allow a network administrator to maintain the network.

External applications created by third parties are often used to perform specialized monitoring of a distributed computer network. For example, an external application may perform intrusion detection monitoring, e.g., virus detection. External applications also generate network events in response to detecting certain conditions. However, current network management systems are not configured to interpret and decode third party network events.

Currently, third party network events are placed in an event browser of the network management system. In order to take action on a third party network event, the network administrator must actually see the network event and react to the network event. As this requires a human response to the network event, response time is typically very slow. Moreover, in the case of a serious network issue, such as virus attacks, a human response may be too slow to be effective. Network administrators typically perform a number of responsibilities, and may not be able to watch for specific network events.

Attempts have been made to integrate external applications with network management systems to allow for the processing of third party network events at the network management systems. For example, some network management systems have made an application programming interface (API) available for integration with the external application. However, this requires that the recognition of the external application be hard-coded into the network management system. The programming of the network management system in this manner is incredibly complex, and requires a computer programmer to perform the actual coding. This programming can take a very long time to perform, and is inherently fraught with potential programming errors because the software of the network management system requires extensive non-recoverable engineering.

### DISCLOSURE OF THE INVENTION

Various embodiments of the present invention, a method and system for event-driven network management, are described herein. In one embodiment, a network management application is configured to detect a network event generated by an external application and to execute an action in response to detecting said network event, wherein the network management application is configurable to receive information describing the network event and the action. The network event is monitored for. In response to detecting the network event, the action is executed.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of one embodiment of a computer system network upon which the present invention may be practiced.

FIG. 2 is a block diagram of components of a network management system for event-driven network management, in accordance with an embodiment of the present invention.

FIG. 3 is a flowchart of a process for event-driven network management, in accordance with an embodiment of the present invention.

The drawings referred to in this description should not be understood as being drawn to scale except if specifically noted.

### BEST MODE FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. In other instances, well known methods, procedures, components, and circuits have not been described in detail as not to unnecessarily obscure aspects of the present invention.

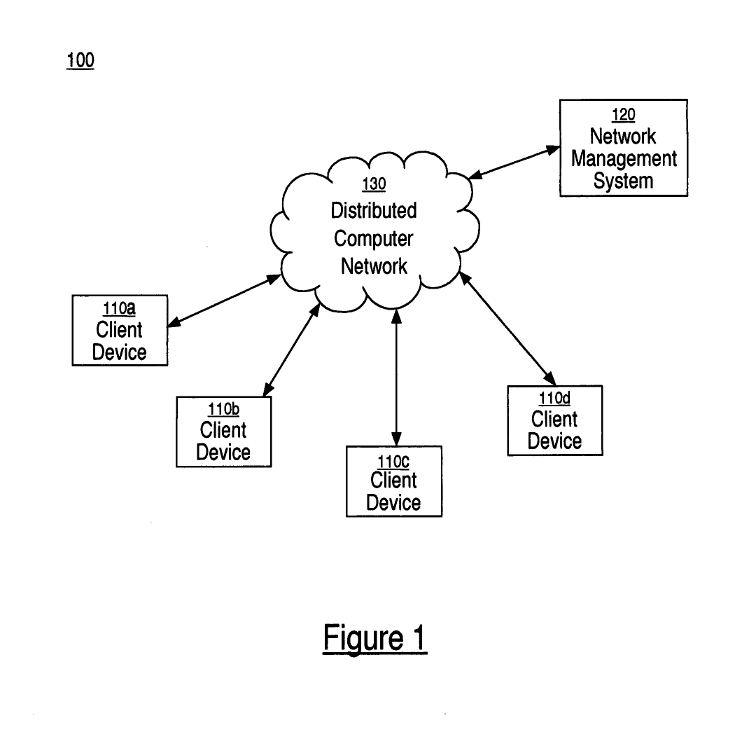

Referring now to FIG. 1, a block diagram of a computer system network 100 upon which the present invention may be practiced is shown. As depicted in FIG. 1, system 100 comprises a plurality of client devices 110a-d communicatively coupled to network management system 120 via a distributed computer network 130. In one embodiment, network communications of client devices 110a-d are monitored by network management system 120. Network management system 120 is also operable to monitor the status and performance of client devices 110a-d.

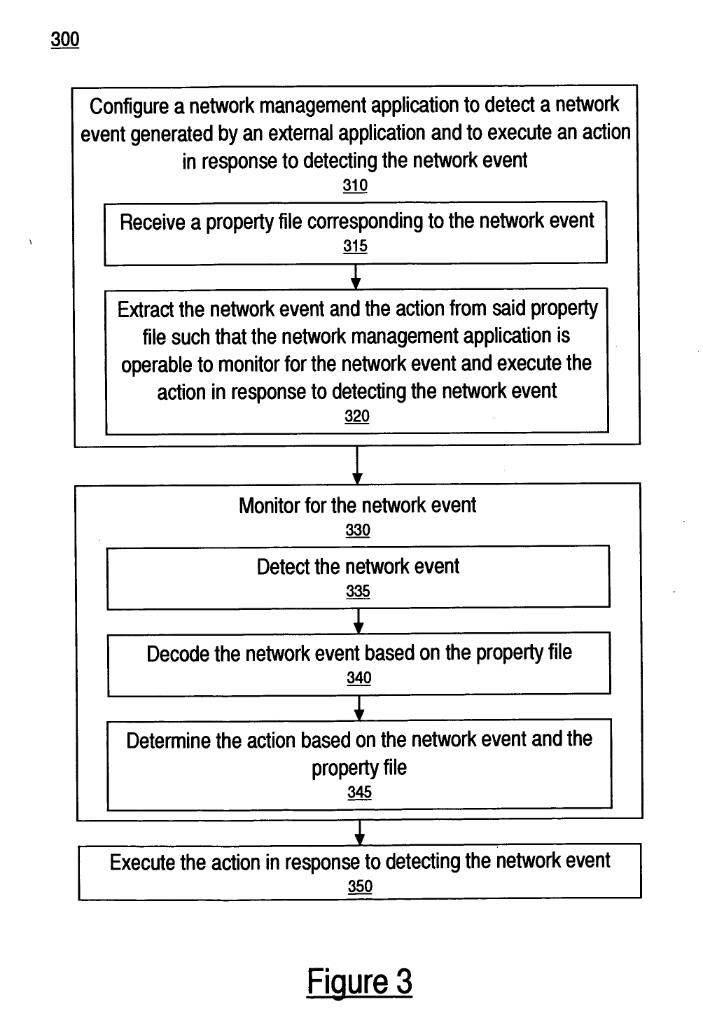

In one embodiment, network management system 120 performs a method for event-driven network management (e.g., process 300 of FIG. 3). Client devices 110a-d communicate with network management system 120 via the communications protocols of distributed computer network 130, hereafter referred to as network 130. It should be appreciated that client device 110a-d can comprise any number or combination of electronic devices, including but not limited to: routers, hubs, application servers, personal computer systems, network switches, handheld computer systems, or any electronic device capable of network communications.

Referring still to FIG. 1, network 130 includes well-known network technologies. For example, network 130 can be implemented using local area network (LAN) technologies (e.g., Ethernet, Tokenring, etc.), the Internet, or other wired or wireless network technologies. The communications links between network management system 120, client devices 110a-d and network 130 can be implemented using, for example, a telephone circuit, communications cable, optical cable, wireless link, or the like.

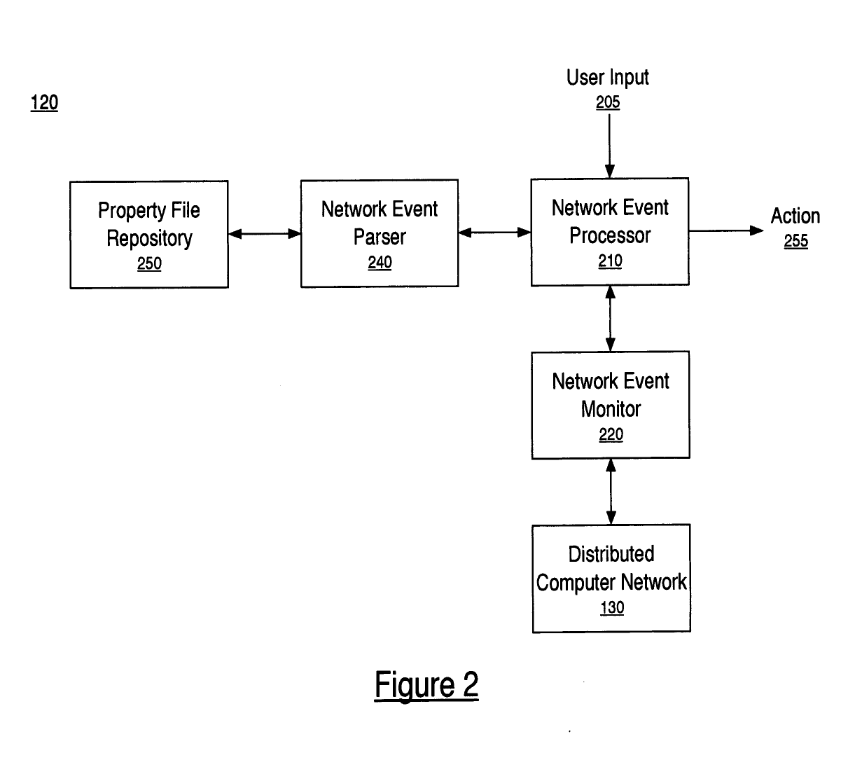

FIG. 2 is a block diagram of components of network management system 120 for event-driven network management, in accordance with an embodiment of the present invention. In one embodiment, network management system 120 is comprised within an application server communicatively coupled to network 130. In one embodiment, the components of network management system 120 are distributed across hardware devices of a distributed computer network. It should be appreciated that the shown and described components of network management system 120 may be implemented as hardware, software or firmware, or any combination thereof. It should also be appreciated that network management system 120 may comprise more components than those shown so as not to unnecessarily obscure aspects of the present invention.

Network management system 120 includes network event processor 210, network event monitor 220, network event parser 240, and property file repository 250. Network event processor 210 is for configuring network management system 120 to detect a network event, also referred to herein as a trap, generated by an external application and to execute an action in response to detecting the network event. Network event processor 210 is configurable to receive information describing the network event and the action. In one embodiment, this information is based on a property file located in property file repository 240.

An external application is an application that operates separately from network management system 120. The external application is operable to monitor network 130 and to generate network events based on the monitoring of network 130. These network events are communicated to network management system 120. In one embodiment, the network event is a Simple Network Management Protocol (SNMP) event. In another embodiment, the network event is a System Log (Syslog) Protocol event.

For example, the external application may be an intrusion detection application for monitoring whether a virus has invaded network 130. In response to detecting a virus, it is desirable to perform some action, such as notifying a network administrator or automatically turning off a port associated with the virus. Other examples of external applications include network jitter detection, wireless connectivity monitoring, and other specialized network monitoring that is not internal to network management system 120.

In one embodiment, network event processor 210 is configurable to recognize network events generated by an external application based on a property file. The property file includes information specifying the network event. In one embodiment, information specifying an action for execution in response to detecting the network event is also included in the property file. The property file is located in property file repository 250. It should be appreciated that property file repository 250 may include any number of property files for configuring network event detection of network management system 120.

In one embodiment, the network management system 120 is configured to detect a particular network event upon placing a property file associated with the network event in property file repository 250. In one embodiment, property file repository 250 is located at a particular directory of network management system 120. For example, property file repository 250 may reside in the . . . /server/config/devConfig/extern directory on the server upon which network management system 120 resides.

A property file is configured to include information related to a particular network event, allowing network event processor 210 to decode a received network event generated by an external application. In essence, the property file includes all information necessary for network event processor 210 to interpret the network event and properly use the data of the network event. For instance, the property file includes information for allowing network management system 120 to carry out actions automatically in response to an event.

In one embodiment, the property file is configured according to a particular syntax. The property file may be user generated, or supplied with the external application. The following attributes are examples of the information that may be included in a property file:
SEVERITY—The severity of the event. A network administrator or developer may determine the severity. Exemplary values include:
   Informational
   Warning
   Minor
   Major
   Critical
FRIENDLY_NAME—A descriptive name used to identify the event
BASE_TEXT—The base text for the network event, this can have place holders in it such as %VARIABLE_NAME_{—}1, %VARIABLE_NAME_{—}2, etc. If the BASE_TEXT key entry is not in the definition file a “toString” will be done on the network event protocol data unit (PDU).
VARIABLE_NAME_X—X is the variable number; for example, if there are three variables they would be named VARIABLE_NAME_{—}1, VARIABLE_NAME_{—}2, VARIABLE_NAME_{—}3. The VARIABLE_NAME key can define the a variable of the PDU in two ways . . .
   Defining the INDEX tag. The INDEX tag defines the index into the PDU for this specific value.
   Defining the INDEX tag and also defining the TABLE_NAME tag. The TABLE_NAME tag should be used the value at the specified index needs to be translated to another value.
XXX_TABLE—A list of name/value pairs used to translate values located at an index of the PDU to another value.

In one embodiment, the root node of the property file must adhere to a particular naming convention. For example, the name of the root node of the property file must be the object identifier (OID) of the trap with “.” delimiter replaced with a “_” delimiter. For example, if the OID of the trap is 1.3.4.1.6.1.11 the root node name will be 1_{—}3_{—}4_{—}1_{—}6_{—}1_{—}11.

The following are examples of property files having no variables, having variables, and having variables and tables, respectively:

Example .trp file with with no variables

1_3_1_4_6_1_11{

SEVERITY=Informational
FRIENDLY_NAME=IDS initialization trap
BASE_TEXT=IDS started and running

}

Example .trp file with variables

1_3_1_4_6_1_12{

SEVERITY=Major
FRIENDLY_NAME=Intrusion detected
BASE_TEXT= Intrusion detected on %PORT_NUM.

Intruder = %INTRUDER.

VARIABLES{

PORT_NUM{

INDEX=0

}
INTRUDER{

INDEX=1

}

}

}

Example .trp file with variables and tables

1_3_1_4_6_1_13{

SEVERITY=Critical
FRIENDLY_NAME=Rogue AP detected
BASE_TEXT= Rogue AP %IP_ADDRESS detected on

radio %RADIO_NUM. Detected by %DETECTION_METHOD

VARIABLES{

IP_ADDRESS {
INDEX=0

}
RADIO_NUM{

INDEX=1

}
DETECTION_METHOD{

INDEX=2
TABLE_NAME=DETECTION_TABLE

}

}
TABLES{

DETECTION_TABLE{

1=Scanning
2=Association
3=Attempted Authentication

Still with reference to FIG. 2, network event parser 240 is for extracting the network event and the action, if included, from the property file such that network event processor 210 is operable to monitor for the network event over network event monitor 220 and execute the action in response to detecting the network event. In one embodiment, network event processor 210 is operable to determine the action based on the network event and the property file. Upon extracting the network event from the property file, network event monitor 220 is operable to monitor network 130 for the network event. In one embodiment, network monitor 220 is operable to detect the network event and to decode the network event based on the property file.

In one embodiment, network event processor 210 is also operable to receive user input 205 to set up actions based on the network event. For example, information describing the action may not be included in the property file. A user can configure action 255 for execution in response to a network event. The information describing the action may be input using the user interface of network management system 120.

FIG. 3 is a flowchart diagram illustrating steps of a process 300 for event-driven network management, in accordance with one embodiment of the present invention. In one embodiment, process 300 is carried out by processors and electrical components under the control of computer readable and computer executable instructions (e.g., network management system 120 of FIG. 1). Although specific steps are disclosed in process 300, such steps are exemplary. That is, the embodiments of the present invention are well suited to performing various other steps or variations of the steps recited in FIG. 3.

At step 310 of process 300, a network management application (e.g., network management system 120 of FIG. 1) is configured to detect a network event generated by an external application. In one embodiment, the network management application is also configured to execute an action in response to detecting the network event. The network management application is configurable to receive information describing the network event and the action. In one embodiment, the network event is SNMP event. In another embodiment, the network event is a Syslog Protocol event.

At step 315, a property file corresponding to the network event is received. The property file includes information specifying the network event. In one embodiment, the property file also includes information specifying the action. In one embodiment, the property file includes a severity level of the network event and text identifying the network event.

At step 320, the network event is extracted from the property file such that the network management application is operable to monitor for the network event. In one embodiment, the action is also extracted from the property file such that the network management application is operable to execute the action in response to detecting the network event. It should be appreciated that steps 315 and 320 describe particular embodiments, and are thus optional.

At step 330, the network event is monitored for. In one embodiment, as shown at step 335, the network event is detected. At step 340, the network event is decoded based on the property file. At step 345, the action is determined based on the network event and the property file. It should be appreciated that steps 335, 340, and 345 describe particular embodiments, and are thus optional.

At step 350, the action is executed in response to detecting the network event. In one embodiment, information describing the action is included and described in the property file. In another embodiment, information describing the action is received as user input directing the network management system to execute the action in response to detecting the network event described in the property file.

In summary, in its various embodiments, the present invention provides for a method and system for event-driven network management. The described invention allows for configuration of a network management system to understand network events generated by external applications, such as third party applications. Furthermore, the present invention allows for configuring the network management system to execute particular actions in response to detecting such a network event. By providing a property file for decoding a received network event generated by an external application, the present invention provides for simple configuration of the network management system. The property file does not require experience with computer programming, reducing the time required to create the property file and reducing the level of expertise of the person creating the property file. Accordingly, the property file of the present invention can be created by a network administrator rather than a computer programmer. Moreover, the property file may be included in the documentation of the external application, in which the network administrator need only place the property file in the appropriate directory. The property file may be created a software wizard which simplifies the entry and ensures the proper syntax is used.

Various embodiments of the present invention, a method and system for a method for event-driven network management, are described herein. While the present invention has been described in particular embodiments, it should be appreciated that the present invention should not be construed as limited by such embodiments, but rather construed according to the following claims.

What is claimed is:

1. A method for event-driven network management, said method comprising:
configuring a network management application to detect a network event generated by an external application and to execute an action in response to detecting said network event, wherein said network management application is configurable to receive information describing said network event and said action;
monitoring for said network event; and
in response to detecting said network event, executing said action.

2. The method as recited in claim 1 wherein said configuring said network management application comprises:
receiving a property file corresponding to said network event with said network management application, wherein said property file comprises information specifying said network event and information specifying said action; and
extracting said network event and said action from said property file such that said network management application is operable to monitor for said network event and execute said action in response to detecting said network event.

3. The method as recited in claim 2 wherein said property file comprises:
a severity level of said network event; and
text identifying said network event.

4. The method as recited in claim 2 wherein said monitoring for said network event comprises:
detecting said network event; and
decoding said network event based on said property file.

5. The method as recited in claim 4 wherein said monitoring for said network event further comprises determining said action based on said network event and said property file.

6. The method as recited in claim 1 wherein said network event is a Simple Network Management Protocol (SNMP) event.

7. The method as recited in claim 1 wherein said network event is a System Log (Syslog) Protocol event.

8. A network management system comprising:
a network event processor for configuring said network management system to detect a network event generated by an external application and to execute an action in response to detecting said network event, wherein said network management processor is configurable to receive information describing said network event and said action; and
a network monitor for monitoring for said network event.

9. The network management system as recited in claim 8 further comprising:
a property file repository for receiving a property file corresponding to said network event, wherein said property file comprises information specifying said network event and information specifying said action; and
a network event parser for extracting said network event and said action from said property file such that said network event processor is operable to monitor for said network event and execute said action in response to detecting said network event.

10. The network management system as recited in claim 9 wherein said property file comprises:
a severity level of said network event; and
text identifying said network event.

11. The network management system as recited in claim 9 wherein said network monitor is operable to detect said network event and to decode said network event based on said property file.

12. The network management system as recited in claim 11 wherein said network event processor is operable to determine said action based on said network event and said property file.

13. The network management system as recited in claim 8 wherein said property file repository is located at a particular directory of said network management system.

14. The network management system as recited in claim 8 wherein said network event is a Simple Network Management Protocol (SNMP) event.

15. The network management system as recited in claim 8 wherein said network event is a System Log (Syslog) Protocol event.

16. A computer-usable medium having computer-readable program code embodied therein for causing a computer system to perform a method for event-driven network management, said method comprising:
configuring a network management application to detect a network event generated by an external application and to execute an action in response to detecting said network event, wherein said network management application is configurable to receive information describing said network event and said action;
monitoring for said network event; and
in response to detecting said network event, executing said action.

17. The computer-usable medium as recited in claim 16 wherein said configuring said network management application comprises:
receiving a property file corresponding to said network event with said network management application, wherein said property file comprises information specifying said network event and information specifying said action; and
extracting said network event and said action from said property file such that said network management application is operable to monitor for said network event and execute said action in response to detecting said network event.

18. The computer-usable medium as recited in claim 17 wherein said property file comprises:
a severity level of said network event; and
text identifying said network event.

19. The computer-usable medium as recited in claim 17 wherein said monitoring for said network event comprises:
detecting said network event; and
decoding said network event based on said property file.

20. The computer-usable medium as recited in claim 19 wherein said monitoring for said network event further comprises determining said action based on said network event and said property file.
